(19) United States
(12) Patent Application Publication
(10) Pub. No.: US 2024/0066807 A1
(43) Pub. Date: Feb. 29, 2024

(54) MEASURING DEVICE, MANUFACTURING DEVICE COMPRISING SUCH A MEASURING DEVICE, AND METHOD FOR OPERATING A MANUFACTURING DEVICE FOR GENERATIVE MANUFACTURING OF A COMPONENT PART FROM A POWDER MATERIAL

(71) Applicant: TRUMPF Laser- und Systemtechnik GmbH, Ditzingen (DE)

(72) Inventors: Valentin Blickle, Stuttgart (DE); Julia Peters, Philadelphia, PA (US); Marc Gronle, Renningen (DE)

(21) Appl. No.: 18/503,204

(22) Filed: Nov. 7, 2023

Related U.S. Application Data
(63) Continuation of application No. PCT/EP2022/060860, filed on Apr. 25, 2022.

(30) Foreign Application Priority Data
May 10, 2021 (DE) 102021204729.7

(51) Int. Cl. B29C 64/393; B29C 64/153; B33Y 50/02

(52) U.S. Cl. CPC B29C 64/393; B29C 64/153; B33Y 50/02; B33Y 30/00

(57) ABSTRACT

A measuring device for aligning a blueprint coordinate system with a build level coordinate system of a working region of a generative manufacturing device arranged in a build level includes a first sensor device configured to cover a first coverage region of the working region with a first measurement accuracy, a selection module configured to select at least one region of interest within the first coverage region, a second sensor device configured to cover the at least one selected region of interest with a second measurement accuracy, the second measurement accuracy being higher than the first measurement accuracy, and an alignment module configured to determine at least one alignment of the blueprint coordinate system relative to the build level coordinate system, including an angle alignment and/or a translation alignment, based on the covered region of interest.

### CROSS REFERENCE TO RELATED APPLICATIONS

This application is a continuation of International Application No. PCT/EP2022/060860 (WO 2022/238099 A1), filed on Apr. 25, 2022, and claims benefit to German Patent Application No. DE 10 2021 204 729.7, filed on May 10, 2021. The aforementioned applications are hereby incorporated by reference herein.

### FIELD

Embodiments of the present invention relate to a measuring device, a manufacturing device comprising such a measuring device, and a method for operating a manufacturing device for generative manufacturing of a component part from a powder material.

### BACKGROUND

The problem often occurs in the manufacturing of component parts by means of generative manufacturing methods that a component part to be manufactured has to be arranged very exactly, i.e., with high spatial accuracy, in a working region of a generative manufacturing device used for producing the component part. This is the case in particular in the manufacturing of so-called hybrid component parts, in which an generatively manufactured region is built up on a conventionally produced preform. The accuracy of the alignment of the region to be newly produced relative to the preform is often crucial here in deciding whether the hybrid manufacturing method can provide an accuracy needed for the later use of the component part at all. For example, a milling head built up in a hybrid manner with internal cooling ducts has to be positioned with a variance of less than 50 μm in order to prevent the resulting component part—which rotates in the later application—from having an excessive imbalance. Optimization to various length scales is needed for correct positioning of the component part to be manufactured within the working region. In this case, it is possible only with great effort, or barely at all, to achieve the above-described optimization tasks on various length scales with high accuracy and efficiency.

### SUMMARY

Embodiments of the present invention provide a measuring device for aligning a blueprint coordinate system with a build level coordinate system of a working region of a generative manufacturing device arranged in a build level. The measuring device includes a first sensor device configured to cover a first coverage region of the working region with a first measurement accuracy, a selection module configured to select at least one region of interest within the first coverage region, a second sensor device configured to cover the at least one selected region of interest with a second measurement accuracy, the second measurement accuracy being higher than the first measurement accuracy, and an alignment module configured to determine at least one alignment of the blueprint coordinate system relative to the build level coordinate system, including an angle alignment and/or a translation alignment, based on the covered region of interest.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a first exemplary embodiment of a manufacturing device for generative manufacturing of a component part from a powder material, comprising a first exemplary embodiment of a measuring device; and

FIG. 2 shows a schematic illustration of a second exemplary embodiment of a manufacturing device for generative manufacturing of a component part from a powder material, comprising a second exemplary embodiment of a measuring device.

### DETAILED DESCRIPTION

Embodiments of the present invention provide a measuring device, a manufacturing device comprising such a measuring device, and a method for operating a manufacturing device for generative manufacturing of a component part from a powder material, wherein the mentioned disadvantages are at least reduced, and preferably do not occur.

According to some embodiments, a measuring device is provided for aligning a blueprint coordinate system on a build level coordinate system of a working region of a generative manufacturing device arranged in a build level, wherein the measuring device includes a first sensor device, which is configured to cover a first coverage region of the working region with a first measurement accuracy. The measuring device additionally includes a selection module, which is configured to select at least one region of interest within the first coverage region. Furthermore, the measuring device includes a second sensor device, which is configured to cover the at least one selected region of interest with a second measurement accuracy, wherein the second measurement accuracy is higher than the first measurement accuracy. The measuring device includes an alignment module, which is configured to determine at least one alignment the blueprint coordinate system relative to the build level coordinate system selected from an angle alignment and a translation alignment, on the basis of the covered region of interest. The measuring device advantageously permits a very accurate alignment of the blueprint coordinate system relative to the build level coordinate system, due to which it is possible in particular to build up regions to be generatively manufactured of component parts on conventionally produced preforms with high accuracy and thus manufacture hybrid components having high quality. In this case, the first sensor device in particular advantageously enables coverage of a comparatively large coverage region, preferably the entire working region, on a first larger length scale, wherein the at least one region of interest can be selected by means of the selection module within this coverage region. The second sensor device then enables the coverage—preferably on a smaller length scale and locally—of the region of interest with higher measurement accuracy. Therefore, in particular, a complete overview can initially be obtained, and it is then possible to cover regions of particular relevance with higher accuracy. Finally, it is advantageously possible using the alignment module to align the blueprint coordinate system relative to the build level coordinate system in particular on the basis of the region of interest covered with higher measurement accuracy, so that overall—with nevertheless advantageously restricted complexity—a high accuracy is obtained for the alignment of the coordinate systems relative to one another. In particular, the measuring device proposed here enables a sensor fusion of the first sensor device with the second sensor device, in particular preferably a multiscale sensor fusion, in particular on various length scales.

A blueprint coordinate system is understood in the context of the present technical teaching in particular as a coordinate system of the component part to be manufactured. In particular, the component part to be manufactured is first defined here by means of a manufacturing data set in the blueprint coordinate system, in which case, when the manufacturing data set is used in the generative manufacturing device, the blueprint coordinate system corresponds to a machine coordinate system of the generative manufacturing device. The machine coordinate system comprises those coordinates with which the manufacturing device—in particular a scanner unit for moving an optical working beam—is activated to manufacture the component part to be manufactured.

A build level coordinate system, in contrast, is understood in the context of the present technical teaching in particular as a coordinate system which is formed in the build level of the manufacturing device and is fixed relative to the working region. Therefore, in particular, the location of at least one preform arranged in the working region is also fixed in the build level coordinate system; in particular, it is possible that the at least one preform defines the build level coordinate system, for example defines the origin of the build level coordinate system. Alternatively or additionally, it is preferably provided that the build level coordinate system is fixed relative to a substrate plate held in particular in an exchangeable manner on or in the manufacturing device or is defined by the substrate plate.

The blueprint coordinate system and the build level coordinate system can move apart even in the case of preceding calibration, in particular due to misalignment or thermal effects in the generative manufacturing device; in particular, they can drift relative to one another upon heating or cooling of the manufacturing device. In particular, it is possible that a substrate plate on which a component part is generatively manufactured thermally expands, in particular when it is preheated, for example to 200° C. or 500° C. Aligning the coordinate systems relative to one another before beginning manufacturing therefore at least increases their quality. Furthermore, it is possible that it is not known with sufficiently high accuracy where the at least one preform is arranged in the build level and how it is aligned, and this can be ascertained with the aid of the measuring device proposed here and taken into consideration in the alignment of the coordinate systems or used for the alignment.

A measurement accuracy of a sensor device is understood in the context of the present technical teaching in particular as a combination of a precision determined in particular by the resolution of the sensor device and a correctness of the detection by the sensor device influenced in particular by a so-called registration error. The precision describes scattering of the measured values around a mean value here, where the precision is high if the scattering is low. The correctness describes a variance of the mean value of the measured values from an assumed real value, in particular from a location in the machine coordinate system. A registration error of the sensor device is in particular a variance of a sensor coordinate system of the sensor device from the machine coordinate system. The correctness is therefore directly dependent on the registration error; in particular, the correctness is high if there is no registration error and the sensor coordinate system corresponds to the machine coordinate system. The measurement accuracy is high if both the precision and the correctness are high. The measurement accuracy is low if either the precision or the correctness is low, or if the precision and the correctness are low. The second measurement accuracy can be higher than the first measurement accuracy in that the precision of the second sensor device with equal correctness is higher than the precision of the first sensor device, or in that the correctness of the second sensor device with equal precision is higher than the correctness of the first sensor device, or in that both the precision and the correctness of the second sensor device are higher than the precision and the correctness of the first sensor device.

In one preferred embodiment, the second measurement accuracy is higher by a factor of at least 2, preferably at least 3, than the first measurement accuracy. In particular, a second geometric resolution of the second sensor device is preferably higher by a factor of at least 2 to preferably at most 10, preferably at least 3 to preferably at most 5, than a first geometric resolution of the first sensor device.

In one preferred embodiment, the first sensor device has a geometric resolution of at least 30 μm to at most 500 μm, preferably of at least 100 μm to at most 400 μm, preferably up to at most 300 μm, preferably at most 200 μm. Alternatively or additionally, the second sensor device has a geometric resolution of at least 10 μm to at most 50 μm, preferably of at least 20 μm to at most 40 μm, preferably up to at most 30 μm.

In one preferred embodiment, the first sensor device is configured to cover the entire working region of the manufacturing device as the first coverage region. Alternatively, it is possible in one preferred embodiment that the first sensor device is configured to cover the first coverage region—as a region which is smaller than the working region—within the working region.

A region of interest is understood in the context of the present technical teaching in particular as a so-called region of interest (ROI).

In one preferred embodiment, it is provided that the at most one region of interest is identical to the coverage region. Alternatively, it is preferably provided that the at least one region of interest is smaller than the first coverage region. In one preferred embodiment, the selection module is configured to select a plurality of regions of interest within the first coverage region. The regions of interest can be spaced apart from one another or can adjoin one another at least in some regions. It is also possible that the regions of interest at least partially overlap one another. In particular, the region of interest is preferably a second coverage region within the first coverage region.

An angle alignment is understood in the context of the present technical teaching in particular as at least one angle by which the blueprint coordinate system is pivoted relative to the build level coordinate system.

A translation alignment is understood in the context of the present technical teaching in particular as a linear distance by which the blueprint coordinate system is shifted relative to the build level coordinate system—or vice versa. In particular, the shift preferably relates to the origins of the coordinate systems.

The alignment of the coordinate systems being determined relative to one another is preferably understood to mean that the coordinate systems are aligned to one another, i.e., in particular that the ascertained shift and/or pivot is corrected. Alternatively, an offset, i.e., the shift and/or pivot, between the coordinate systems is preferably ascertained, in which case further processing, in particular manufacturing of the component part to be manufactured, is carried out on the basis of the ascertained offset; this means in particular that the ascertained offset is taken into consideration in the further processing, in particular computed out.

The measuring device preferably comprises a plurality of second sensor units, in particular if the manufacturing device for generative manufacturing of the component part to be manufactured comprises a plurality of working beams. In particular, a second sensor device is preferably assigned to each working beam, or each working beam is part of a second sensor device.

A module can preferably be implemented in the measuring device in hardware, but also in software. In particular, the functionality of a module can preferably be implemented in the measuring device in hardware and/or software. The module does not necessarily have to be a separate physically or conceptually separable unit or structure here. A module can in particular comprise a plurality of submodules. In particular, a module is preferably a software unit.

Generative manufacturing is to be understood in the context of the present technical teaching in particular as additive manufacturing of a component part. In particular, this is understood to mean building a component part from powder material layer by layer, in particular a manufacturing method selected from a group consisting of selective laser sintering, selective laser melting, laser metal fusion (LMF), direct metal laser melting (DMLM), laser net shaping manufacturing (LNSM), and laser engineered net shaping (LENS). Accordingly, the manufacturing device is configured in particular to perform at least one of the above-mentioned generative manufacturing methods.

According to an embodiment of the invention, it is provided that the alignment module is configured to determine the angle alignment of the blueprint coordinate system relative to the build level coordinate system on the basis of at least one covered region which is selected from a group consisting of the covered first coverage region and the covered region of interest. In addition, the alignment module is configured to determine the translation alignment of the blueprint coordinate system relative to the build level coordinate system on the basis of the covered region of interest. In one preferred embodiment, at least the translation alignment of the blueprint coordinate system relative to the build level coordinate system is therefore determined on the basis of the covered region of interest. The translation alignment is advantageously determinable here with high accuracy on the basis of the covered region of interest, since the second measurement accuracy is higher than the first measurement accuracy, wherein a high measurement accuracy is advantageous in particular for the determination of the translation alignment. The angle alignment, in contrast, can electively also be determined on the basis of the covered region of interest or on the basis of the first coverage region. A high measurement accuracy is also advantageous for determining the angle alignment, but it is also possible that the first lower measurement accuracy is sufficient for the needed accuracy in the determination of the angle alignment. Since the angle alignment can be determined with high accuracy on a larger length scale, for example, on the basis of the course of complete edges traversing the coverage region, the angle alignment can also be determined on the basis of the first coverage region.

In one preferred embodiment, in which both angle alignment and the translation alignment are determined on the basis of the covered region of interest, the first coverage region is preferably used to select the at least one region of interest, in particular to identify and select it.

According to an embodiment of the invention, it is provided that the alignment module is configured to recognize at least one location determination feature of at least one preform arranged in the working region. The alignment module is additionally configured to define a geometric location of the at least one location determination feature relative to at least one coordinate system, wherein the at least one coordinate system is selected from a group consisting of the build level coordinate system and the blueprint coordinate system. By means of the recognition of the location determination feature and the possibility of defining its location relative to at least one coordinate system, it is advantageously possible to establish the arrangement of the preform in the working region with high accuracy and thus in turn to build the region of the component part to be additively manufactured with high accuracy on the preform. Since the relative location of the coordinate systems in relation to one another can be determined with high accuracy, the geometric location of the preform is known in both coordinate systems with high accuracy as soon as it is determined for one of the two coordinate systems.

Alternatively or additionally, the alignment module is configured to align the blueprint coordinate system relative to the at least one location determination feature. This represents a simple embodiment, since the location determination feature can be detected well. An implicit alignment of the blueprint coordinate system to the build level coordinate system takes place here, wherein the build level coordinate system can be defined in particular by the location determination feature. In this respect, the preform arranged in the working region and thus also in the build level preferably forms the build level coordinate system with the at least one location determination feature.

In one preferred embodiment, the at least one location determination feature is a borehole in the preform detectable by means of the first sensor device and/or by means of the second sensor device. Such a borehole can preferably be identified in particular by means of image recognition.

In one preferred embodiment, the at least one location determination feature is an edge of the preform detectable by means of the first sensor device and/or by means of the second sensor device. Such an edge is in particular to be understood as an edge identifiable by machine, in particular an edge identifiable with the aid of an edge detection algorithm. Such an edge identification enables an ascertainment of the position of the preform in a very precise and at the same time not very complex manner. In one preferred embodiment, the edge can in particular be a borehole edge of a borehole in the preform.

Alternatively or additionally, the at least one location determination feature is preferably a marking which is provided on a surface of the preform. A very high accuracy of the position ascertainment for the preform can also be achieved in this way.

The surface of the preform on which the marking is arranged in particular faces toward the first sensor device and/or the second sensor device. In particular, it is an upper side of the preform.

A marking on a surface of the preform preferably introduces at least one edge there, which can then be in turn identified by means of edge identification, in particular automatically.

According to an embodiment of the invention, it is provided that the first sensor device is designed as an optical sensor device configured to record an optical image of the first coverage region. The first sensor device preferably comprises at least one camera. The first sensor device, in particular the at least one camera, is preferably a component of a powder bed monitoring device of a manufacturing device for generatively manufacturing a component part from a powder material, in particular a powder bed camera. In this case, no additional components are advantageously needed to provide the first sensor device. An optical sensor device can in particular have a geometric resolution of at least 30 μm to at most 500 μm, preferably of at least 100 μm to at most 400 μm, preferably up to at most 300 μm, preferably up to at most 200 μm.

According to an embodiment of the invention, it is provided that the second sensor device is configured to activate a scanner device for moving an optical working beam of the generative manufacturing device in the working region in order to detect signal values from electromagnetic radiation originating an interaction region of the optical working beam in a location-dependent manner, wherein a signal value is assigned to each location of the movement of the optical working beam in the working region, and to obtain an image of the working region from the signal values detected in a location-dependent manner. A second sensor device designed in this way advantageously has a very high measurement accuracy. In particular, a second sensor device designed in this way can have a high resolution and/or a very low, preferably even negligible registration error. Furthermore, a manufacturing device for generatively manufacturing a component part from a powder material, which uses an optical working beam for the generative manufacturing, advantageously does not require complex additional devices to implement the second sensor device, since in any case the scanner device for moving the optical working beam in the working region is provided anyway. A second sensor device designed in this way can in particular have a geometric resolution of at least 10 μm to at most 50 μm, preferably of at least 20 μm to at most 40 μm, preferably up to at most 30 μm.

An optical working beam is understood to mean in particular directed electromagnetic radiation, in continuous or pulsed form, which, in terms of its wavelength or a wavelength range, is suitable for generative manufacturing of a component part from powder material, in particular for sintering or melting the powder material. An optical working beam is understood to mean in particular a laser beam that can be generated continuously or in a pulsed manner. The optical working beam preferably has a wavelength or a wavelength range within the visible electromagnetic spectrum or within the infrared electromagnetic spectrum or within the overlap range between the infrared range and the visible range of the electromagnetic spectrum.

An interaction region of the optical working beam in the working region is understood in particular as a local region of the working region in which the optical working beam instantaneously interacts with material arranged in the working region, in particular powder material.

Electromagnetic radiation originating from the interaction region being detected is understood in the context of the present technical teaching in particular to mean that electromagnetic radiation radiated from the interaction region, in particular electromagnetic radiation emitted from the interaction region or electromagnetic radiation remitted from the interaction region, is detected.

Electromagnetic radiation radiated from the interaction region is understood here as electromagnetic radiation which—independently of a concrete physical mechanism—originates from the interaction region due to the radiation of the optical working beam into the interaction region.

Electromagnetic radiation emitted from the interaction region is understood as electromagnetic radiation which is emitted due to the interaction with the optical working beam in the interaction region—in particular as thermal radiation or as luminescence, in particular fluorescence or phosphorescence.

Electromagnetic radiation remitted from the interaction region is understood as electromagnetic radiation which is reflected and/or scattered—in particular from a surface in the interaction region. “Reflection” is understood here in the narrower meaning of directed reflection, while “scattering” is understood as diffuse reflection, in particular according to Lambert's law.

The signal values are detected depending on location point by point, in particular one-dimensionally. Each location of the movement of the optical working beam is thus preferably assigned exactly one signal value. Such a signal value is in particular a brightness value.

An image of the working region, in contrast, is understood in particular as a two-dimensional image of the working region, in particular of the at least one selected region of interest of the working region. The image is obtained in particular in that it is composed, computed, or formed in another manner from the signal values detected in a location-dependent manner.

It is preferably provided that the optical working beam for covering the working region is operated using an optical output power which is lower than a lower power limit for the optical output power of the optical working beam for generative manufacturing. In this way, a change of material arranged in the working region, whether it is powder material or a preform, is avoided. The lower power limit is in particular selected here so that a material change, in particular sintering or melting, in particular of powder material of the generative manufacturing device, only occurs from this lower power limit or above this lower power limit, so that generative manufacturing is possible using the optical working beam. The optical output power of the optical working beam is therefore preferably selected to be higher than the lower power limit for the generative manufacturing. An operating mode for covering the at least one selected region of interest on the one hand, and an operating mode for generative manufacturing on the other hand, are therefore clearly separated from one another with respect to the selected optical output power of the optical working beam.

In particular, the same optical working beam—except for any reduction in the optical output power—is used both for the generative manufacturing and for the coverage of the at least one selected region of interest.

The lower power limit according to one preferred embodiment is 100 W, preferably 90 W, preferably 85 W. The optical working beam is preferably operated for covering the working region at an optical output power of at least 1 W to at most 99.9 W, preferably up to at most 89.9 W, preferably up to at most 84.9 W, in particular from at least 2 W to at most 50 W. For generative manufacturing, the optical working beam is preferably operated with an optical output power of at least 90 W, preferably of at least 100 W, preferably greater than 100 W, preferably of at least 90 W to at most 500 W.

By means of the sensor device designed as described above, edge identification is possible in particular on the basis of sharp jumps in the signal values detected in a location-dependent manner. In particular, the emission behaviour of the preform changes discontinuously at an edge. This is also true if the preform is surrounded by powder material, namely working powder of the generative manufacturing device, or is embedded in powder material, wherein the surface of the preform facing toward the scanner device is not covered by powder material. If the optical working beam passes over an edge of the surface, the emission behaviour changes in particular from strong scattering by the powder material to at least more directed reflection on the surface of the preform—or vice versa. The signal value typically has a higher level, in particular a higher or also lower brightness—depending on the type of the coverage—when the light of the optical working beam is diffusely backscattered than when it is essentially reflected.

A working powder is understood as a powder material which is used in the generative manufacturing device or by the generative manufacturing device to produce a component part from the powder material.

The method is preferably carried out using a roughened surface of the preform, in which the surface is preferably blasted using sand, corundum, or glass beads. In this way, the surface of the preform can have matte diffusely scattering optical properties, so that it does not simply appear dark—possibly with individual glossy points—in the image of the working region, but rather is readily identifiable. If the roughness of the surface is set suitably, the result is nonetheless an outstanding contrast to powder material possibly arranged in the surroundings of the surface. For example, it can thus also be possible to increase the signal value from the roughened surface above the level of the signal value of the scattering of the powder material.

According to an embodiment of the invention, it is provided that the sensor device comprises a detection device arranged on the optical axis of the optical working beam and is configured to detect the signal value in a location-dependent manner, in that an output signal of the detection device is assigned in a time-dependent manner to a synchronous state of the scanner device. In this case, the second sensor device advantageously does not have registration errors, since the measurement takes place directly in the coordinate system of the optical working beam and thus in the machine coordinate system. The second measurement accuracy can therefore even be higher than the first measurement accuracy if the resolution of the second sensor device should be less than the resolution of the first sensor device. Nonetheless, the second sensor device preferably also has a higher resolution than the first sensor device.

The detection of the signal values, thus here of the output signal of the detection device, and the movement of the optical working beam by appropriate control of the scanner device take place synchronously in particular, so that a state of the scanner device and therefore at the same time a location in the working region can be assigned to each signal value. The state of the scanner device is in particular a position of at least one movable mirror of the scanner device, in particular a galvanometric mirror, which in turn is again assigned to a location in the working region onto which the optical working beam is directed. The location-resolved detection of the signal values thus takes place directly in the coordinate system of the scanner device and therefore in the machine coordinate system.

The second sensor device preferably comprises a deflection mirror, via which the optical working beam is deflected, wherein the reflectivity of the deflection mirror is less than 100%, so that a fraction of the electromagnetic radiation radiated along the optical axis passes through the deflection mirror and is incident on the detection device arranged behind the deflection mirror. Alternatively, it is also possible that the optical working beam is sent through the deflection mirror, in which case this has a transmissivity of less than 100%, where the detection device in this case is arranged such that the radiated electromagnetic radiation is partially deflected by the deflection mirror and directed to the detection device.

Furthermore, it is also preferably possible that the optical working beam passes through an opening of a deflection mirror, wherein the radiated electromagnetic radiation is at least partially deflected by the surface of the deflection mirror surrounding the opening and directed to the detection device. In particular, a so-called scraper mirror can be used.

If the deflection mirror is configured to deflect the optical working beam and to transmit the radiated electromagnetic radiation, it preferably has a reflectivity of at least 99% to at most 99.98%. If the deflection mirror is configured to transmit the optical working beam and to reflect the radiated electromagnetic radiation, it preferably has a transmissivity of at least 99% to at most 99.98%.

Alternatively, it is also possible to use a polarization beam splitter instead of the deflection mirror, where the optical working beam is preferably linearly polarized in this case. The polarization is at least partially destroyed by the radiation into the interaction region, in which case the polarization direction perpendicular to the incident working beam only contains the radiated signal. The polarization beam splitter therefore preferentially reflects the incident electromagnetic radiation of the optical working beam linearly polarized with a determined polarization direction and transmits the polarization direction perpendicular to the determined polarization direction—or vice versa.

The detection device is preferably designed as a photodiode or comprises at least one photodiode. A silicon photodiode is preferably used as the photodiode. It is possible that the photodiode is sensitive in the visible and/or infrared spectral range. The sensitivity of the photodiode is preferably matched to the wavelength range of the optical working beam. An infrared photodiode or a pyrometer diode can preferably be used.

Alternatively or additionally, the second sensor device comprises a thermal imaging camera, which is arranged and configured to cover the working region. The second sensor device is configured to detect the signal value in a location-dependent manner by recording a thermal image using the thermal imaging camera. The resulting registration error of the second sensor device can be very low or even disappear in this case too, in that the respective position of the optical working beam is advantageously derived from the detected thermal image. For this purpose, in one preferred embodiment, a predetermined intensity profile of the optical working beam, for example a Gaussian profile, can be matched, i.e., fitted, to an intensity curve of the detected thermal radiation detected in the thermal image, wherein a current position of the optical working beam can be identified using a maximum of the predetermined intensity profile matched to the detected intensity curve. In this way, a measurement with at most very small errors in the coordinate system of the optical working beam and thus in the machine coordinate system is possible. In this embodiment as well, the second sensor device can therefore have a higher measurement accuracy than the first sensor device even if its resolution is less than the resolution of the first sensor device, in particular even if the resolution of the thermal imaging camera is less than the resolution of an optical camera of the first sensor device. However, the resolution of the second sensor device is preferably also nonetheless higher than the resolution of the first sensor device in this embodiment.

According to an embodiment of the invention, it is provided that the selection module is configured to automatically select the at least one region of interest. This advantageously saves an operator of the measuring device from having to make a manual selection.

Alternatively or additionally, the selection module is configured to provide a user interface, which enables a selection of the at least one region of interest by a user of the measuring device. This advantageously allows the operator of the measuring device greater freedom in the selection of the at least one region of interest. The measuring device preferably comprises the user interface.

According to an embodiment of the invention, it is provided that the alignment module is configured to automatically determine at least one alignment of the blueprint coordinate system relative to the build level coordinate system, which is selected from a group consisting of the angle alignment and the translation alignment. This advantageously saves an operator of the measuring device from having to make a manual determination of the at least one alignment.

Alternatively or additionally, the alignment module is configured to provide a user interface which enables at least one alignment of the blueprint coordinate system to be determined relative to the build level coordinate system, which is selected from a group consisting of the angle alignment and the translation alignment, by a user of the measuring device. This advantageously allows the operator of the measuring device greater freedom in the determination of the at least one alignment. The measuring device preferably comprises the user interface.

According to an embodiment of the invention, it is provided that the measuring device comprises a representation module which is configured to calculate an overall representation of the at least one selected region of interest in the first coverage region. However, the overall representation advantageously allows both an overview of the first coverage region and also a detailed observation of the at least one region of interest in the same representation.

In particular, the representation module is preferably configured to calculate the overall representation in that a first representation of the first coverage region is overlaid with a second representation of the region of interest. This represents a simple and in particular less computing-intensive and thus resource-conserving embodiment of the overall representation. A degree of overlay of the first representation with the second representation is preferably adjustable, preferably variably adjustable, preferably pre-determinable—in particular variably—by a user.

Alternatively or additionally, the representation module is configured to calculate the overall representation in that the first representation of the first coverage region is offset with the second representation of the region of interest to form the overall representation. This advantageously allows a near exact representation of the region of interest in the overall representation.

According to an embodiment of the invention, it is provided that the representation module is configured to calculate an AR representation of the working region such that, in the AR representation, the overall representation is displayed in the working region, in particular in a visual recording—recorded in real time in particular—of the working region. An AR representation is understood here as a representation according to the principle of augmented reality (AR). The AR representation advantageously allows a user a view of the overall representation within the real working region, in particular in real time.

Preferably, in the AR representation, the overall representation is displayed in the working region, in particular in the visual recording of the working region, in that the overall representation is overlaid with the working region, in particular with the visual recording of the working region. This represents a simple and in particular less computing-intensive and therefore resource-conserving embodiment for generating the AR representation.

According to an embodiment of the invention, it is provided that the representation module is configured to display at least one coordinate system, which is selected from a group consisting of the build level coordinate system and the blueprint coordinate system, in the overall representation or in the AR representation. This advantageously allows a user an accurate overview of the at least one coordinate system in the context of the overall representation or the AR representation.

Alternatively or additionally, the representation module is configured to display irradiation vectors for the generative manufacturing of a component part in the working region in the overall representation or in the AR representation. This advantageously makes it possible for a user to observe and possibly manipulate the irradiation vectors in a directly accessible manner.

An irradiation vector is understood in particular as a continuous, preferably linear movement of the optical working beam in the working region over a specific distance with a specific direction of movement. The irradiation vector thus includes the direction or orientation of the movement.

According to an embodiment of the invention, it is provided that the alignment module is configured to link location information along a coordinate extending perpendicular to the build level with at least one coordinate system, wherein the at least one coordinate system is selected from a group consisting of the build level coordinate system and the blueprint coordinate system. In this manner, 3D height information can advantageously be linked with the at least one coordinate system. For example, a three-dimensional location of the preform in the working region can thus be determined, in particular for the purpose of adjustment or for ascertaining the location of the preform relative to a substrate plate, and/or for defining a zero height location. The location information along the coordinate extending perpendicular to the build level can advantageously be obtained, for example, by means of strip projection or other suitable methods.

Other information can also alternatively or additionally be linked with the at least one coordinate system, for example information about a surface texture, in particular of the at least one preform.

According to an embodiment of the invention, it is provided that the alignment module is configured to align a plurality of optical working beams of the manufacturing device relative to at least one coordinate system, wherein the at least one coordinate system is selected from a group consisting of the build level coordinate system and the blueprint coordinate system. In this manner, multiple optical working beams can advantageously be aligned relative to the at least one coordinate system and therefore at the same time relative to one another, which increases the accuracy of the manufacturing of the component part to be produced if the multiple optical working beams are being used to produce the same component part—in particular to produce various regions of the same component part.

In one preferred embodiment, it is also possible that a plurality of different sensor devices, in particular first and/or second sensor devices, are fused or combined with one another. In particular, different and/or identical sensor devices can be fused or combined with one another here. In particular, it is possible to fuse a plurality of camera images from various cameras with one another. It is also possible to fuse or combine a plurality of second sensor devices, which use an optical working beam, with one another, in particular if a fastening device comprising the measuring device comprises a plurality of optical working beams. In particular, each optical working beam can be assigned to a dedicated second sensor device in this case. Registration of the various optical working beams relative to one another can therefore advantageously be ensured at the same time.

The measuring device is preferably configured to carry out a method according to embodiments of the invention described hereinafter or an embodiment of the method described hereinafter.

Embodiments of the present invention also provide a manufacturing device for generative manufacturing of a component part from a powder material, which comprises a beam device, wherein the beam device is configured to generate at least one optical working beam in order to manufacture a component part by means of the at least one optical working beam generatively from a powder material. The manufacturing device additionally has a working region arranged in a build level, which is configured for generatively manufacturing a component part from the powder material in the working region. Furthermore, the manufacturing device comprises at least one scanner device, which is configured to move the at least one optical working beam in the working region. The manufacturing device comprises a control device, which is operationally connected to the at least one scanner device and is configured to activate the at least one scanner device to move the at least one optical working beam in the working region. The manufacturing device comprises a measuring device according to embodiments of the invention or a measuring device according to one or more of the above-described embodiments. In particular, the advantages that have already been described in connection with the measuring device arise in connection with the manufacturing device.

The selection module, the alignment module, and preferably the representation module are preferably part of the control device or are implemented in the control device. In particular, the functions of the selection module, the alignment module, and preferably the representation module are implemented in the control device or are assumed by the control device.

The manufacturing device is preferably configured for carrying out a method according to embodiments of the invention described hereinafter or an embodiment of the method described hereinafter.

In one embodiment, the beam device is configured to generate a plurality of optical working beams, and/or the manufacturing device comprises a plurality of beam devices for generating a plurality of optical working beams. It is possible that a plurality of respectively assigned scanner devices are provided for the plurality of optical working beams. However, it is also possible that the scanner device is configured to move a plurality of optical working beams—in particular independently of one another—on the working region. In particular, the scanner device can comprise a plurality of separately activatable scanners for this purpose, in particular scanner mirrors.

The scanner device preferably comprises at least one scanner, in particular a galvanometer scanner, a piezo scanner, a polygon scanner, an MEMS scanner, and/or a working head or treatment head movable relative to the working region. The scanner devices proposed here are suitable for moving the optical working beam between a plurality of irradiation positions within the working region.

A working head or treatment head which is movable relative to the working region is understood here to mean in particular an integrated component part of the manufacturing device which has at least one radiation outlet for at least one optical working beam, wherein the integrated component part, that is to say the working head, as a whole is movable in at least one movement direction, preferably in two mutually perpendicular movement directions, relative to the working region. Such a working head may in particular be embodied with a gantry design or be guided by a robot. The working head may in particular be designed as a robot hand of a robot.

The control device is preferably selected from a group consisting of a computer, in particular a personal computer (PC), a plug-in card or control card, and an FPGA board. In one preferred embodiment, the control device is an RTC6 control card from SCANLAB GmbH, in particular in the configuration currently obtainable on the priority date of the present intellectual property right.

The beam device is preferably designed as a laser. The optical working beam is thus advantageously generated as an intense beam of coherent electromagnetic radiation, in particular coherent light. In this respect, irradiation preferably means exposure.

The manufacturing device is preferably configured to carry out a method selected from a group consisting of selective laser sintering, selective laser melting, laser metal fusion (LMF), direct metal laser melting (DMLM), laser net shaping manufacturing (LNSM), and laser engineered net shaping (LENS). These embodiments of the manufacturing device have proven to be advantageous.

According to an embodiment of the invention, it is provided that the manufacturing device comprises an output device, which is operationally connected to the measuring device, in particular to the representation module, and is configured to output at least one representation calculated by the representation module, which is selected from a group consisting of the overall representation and the AR representation. The output device is designed in one preferred embodiment as a display screen or monitor, head-up display, or as data glasses, in particular 3D glasses.

The object is finally also achieved in that a method for operating a manufacturing device for generatively manufacturing a component part from a powder material is provided, wherein a first coverage region of a working region of the manufacturing device arranged in a build level is covered with a first measurement accuracy. At least one region of interest is selected within the first coverage region. The at least one selected region of interest is covered with a second measurement accuracy, wherein the second measurement accuracy is higher than the first measurement accuracy. Finally, at least one alignment of the blueprint coordinate system relative to the build level coordinate system is determined on the basis of the covered region of interest, wherein the at least one alignment is selected from a group consisting of an angle alignment and a translation alignment. In particular the advantages that have already been explained in connection with the measuring device and the manufacturing device arise in connection with the method.

The method preferably comprises at least one method step which was previously explained explicitly or implicitly in connection with the measuring device or the manufacturing device.

According to an embodiment of the invention, it is provided that the angle alignment of the blueprint coordinate system relative to the build level coordinate system is determined on the basis of at least one covered region which is selected from a group consisting of the covered first coverage region and the covered region of interest. The translation alignment of the blueprint coordinate system relative to the build level coordinate system is determined on the basis of the covered region of interest.

According to an embodiment of the invention, it is provided that a geometric location of at least one preform in the build level relative to at least one coordinate system is ascertained, wherein the at least one coordinate system is selected from a group consisting of the build level coordinate system and the blueprint coordinate system. A component part is then preferably generatively built up on the preform.

At least one location determination feature of the preform is preferably identified, and the geometric location of the preform is ascertained in that a geometric location of the at least one location determination feature is defined relative to at least one of the coordinate systems. Alternatively or additionally, the blueprint coordinate system is preferably aligned relative to the at least one location determination feature.

An optical sensor device which is configured to record an optical image of the first coverage region is preferably used as the first sensor device. At least one camera, in particular a powder bed camera, is preferably used as the first sensor device.

In a preferred embodiment, a sensor device is used as the second sensor device which is configured to activate a scanner device to move an optical working beam of the generative manufacturing device in the working region, wherein signal values from electromagnetic radiation originating from an interaction region of the optical working beam in the working region are detected depending on location, wherein a signal value is assigned to each location of the movement of the optical working beam in the working region, and wherein an image of the working region is obtained from the signal values detected in a location-dependent manner.

The signal values are preferably detected by means of a detection device, which is arranged on an optical axis of the optical working beam and preferably comprises at least one photodiode, in that an output signal of the detection device is assigned in a time-dependent manner to a synchronous state of the scanner device. Alternatively or additionally, the working region is preferably covered by a thermal imaging camera, wherein the signal values are detected in a location-dependent manner by recording a thermal image using the thermal imaging camera.

The at least one region of interest is preferably selected automatically. Alternatively or additionally, the at least one region of interest is selected by a user of the measuring device —in particular manually.

Preferably, at least one alignment of the blueprint coordinate system relative to the build level coordinate system selected from the angle alignment and the translation alignment is determined automatically. Alternatively or additionally, the at least one alignment is determined by a user of the measuring device, in particular manually.

Preferably, an overall representation of the region of interest in the covered coverage region is calculated, in particular in that a second representation of the region of interest is overlaid on a first representation of the covered coverage region, and/or in that the first representation of the covered coverage region is offset with the second representation of the region of interest to form the overall representation.

Preferably, an AR representation of the working region is calculated in such a way that, in the AR representation, the overall representation is displayed in the working region, in particular in a visual recording of the working region—in particular recorded in real time —preferably by overlaying the overall representation with the working region, in particular with the visual recording of the working region.

Preferably, at least one coordinate system selected from the build level coordinate system and the blueprint coordinate system is displayed in the overall representation or in the AR representation. Alternatively or additionally, irradiation vectors for the generative manufacturing of a component part in the working region are displayed in the AR representation or in the overall representation.

Preferably, location information along a coordinate extending perpendicular to the build level is linked with at least one coordinate system selected from the build level coordinate system and the blueprint coordinate system.

Preferably, a plurality of optical working beams of the manufacturing device is aligned relative to at least one coordinate system selected from the build level coordinate system and the blueprint coordinate system.

A laser is preferably used as a beam device.

The component part is preferably manufactured by means of a method selected from a group consisting of selective laser sintering, selective laser melting, laser metal fusion (LMF), direct metal laser melting (DMLM), laser net shaping manufacturing (LNSM), and laser engineered net shaping (LENS).

A metal or ceramic powder in particular may preferably be used as powder material.

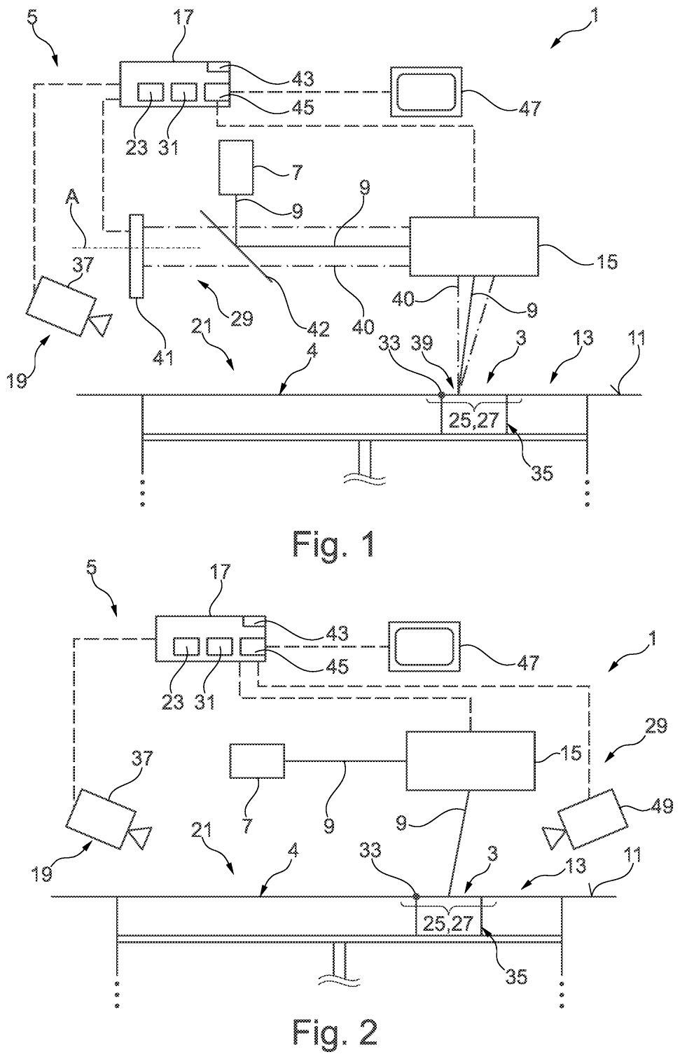

FIG. 1 shows a schematic illustration of a first exemplary embodiment of a manufacturing device 1 for generative manufacturing of a component part 3 from a powder material 4, comprising a first exemplary embodiment of a measuring device 5.

The manufacturing device 1 comprises a beam device 7, which is configured to generate at least one optical working beam 9. The manufacturing device 1 is additionally configured to manufacture the component part 3 generatively from the powder material 4 by means of the at least one optical working beam 9. The manufacturing device 1 additionally comprises a working region 13 arranged in a build level 11, wherein the component part 3 can be generatively manufactured from the powder material 4 in the working region 13. Furthermore, the manufacturing device 1 comprises a scanner device 15, which is configured to move the at least one optical working beam 9 in the working region 13. The manufacturing device 1 additionally comprises a control device 17, which is operationally connected to the at least one scanner device 15 and is configured to activate the at least one scanner device 15 to move the at least one optical working beam 9 in the working region 13.

The manufacturing device 1 moreover comprises the measuring device 5. This is configured to align a blueprint coordinate system with a build level coordinate system of the working region 13. For this purpose, the measuring device 5 comprises a first sensor device 19, which is configured to cover a first coverage region 21 of the working region 13, in particular the entire working region 13, with a first measurement accuracy. The measuring device 5 comprises a selection module 23, implemented in the control device 17 in the exemplary embodiment shown here and configured to select at least one region of interest 25, in particular as a second coverage region 27, within the first coverage region 21. Moreover, the measuring device 5 comprises a second sensor device 29, which is configured to cover the at least one selected region of interest 25 with a second measurement accuracy. The second measurement accuracy is higher than the first measurement accuracy. The measuring device 5 additionally comprises an alignment module 31, which is implemented in the control device 17 in the exemplary embodiment shown here and is configured to determine at least one alignment of the blueprint coordinate system relative to the build level coordinate system selected from an angle alignment and a translation alignment on the basis of the covered region of interest 25. This in particular enables a sensor fusion of the first sensor device 19 with the second sensor device 29, in particular preferably a multiscale sensor fusion, in particular on various length scales.

The alignment module 31 is preferably configured to determine the angle alignment of the blueprint coordinate system relative to the build level coordinate system on the basis of at least one covered region selected from the covered first coverage region 21 and the covered region of interest 25, and to determine the translation alignment of the blueprint coordinate system relative to the build level coordinate system on the basis of the covered region of interest 25.

The alignment module 31 is preferably configured to identify at least one location determination feature 33 of at least one preform 35 arranged in the working region 13, and to define a geometric location of the at least one location determination feature 33 relative to at least one coordinate system selected from the build level coordinate system and the blueprint coordinate system. Alternatively or additionally, the alignment module 31 is configured to align the blueprint coordinate system relative to the at least one location determination feature 33, wherein the blueprint coordinate system in this case is preferably implicitly aligned with the build level coordinate system defined by the location determination feature.

The first sensor device 19 is preferably designed as an optical sensor device configured to record an optical image of the first coverage region 21. The first sensor device 19 preferably comprises a camera 37. The first sensor device 19 is preferably designed as a powder bed camera.

The second sensor device 29 is preferably configured to activate the scanner device 15 to move the optical working beam 9 in the working region 13, in order to detect signal values from electromagnetic radiation 40 originating from an interaction region 39 of the optical working beam 9 in the working region 13 in a location-dependent manner, wherein a signal value is assigned to each location of the movement of the optical working beam 9 in the working region 13, and to obtain an image of the working region 13 from the signal values detected in a location-dependent manner.

In the first exemplary embodiment of the measuring device 5 shown here, the second sensor device 29 comprises a detection device 41, which is preferably arranged on an optical axis A of the optical working beam 9 and preferably comprises at least one photodiode. The second sensor device 29 is configured here to detect the signal values in a location-dependent manner, in that an output signal of the detection device 41 is assigned in a time-dependent manner to a synchronous state of the scanner device 15.

In the first exemplary embodiment shown in FIG. 1, the second sensor device 29 comprises a deflection mirror 42, via which the optical working beam 9 is deflected, wherein the reflectivity of the deflection mirror 42 is less than 100%, so that a fraction of the electromagnetic radiation 40 radiated along the optical axis A passes through the deflection mirror 42 and is incident on the detection device 41 arranged behind the deflection mirror 42.

The selection module 23 is preferably configured to select the at least one region of interest 25 automatically. Alternatively or additionally, the measuring device 5, in particular the control device 17 here, comprises a user interface 43, via which a selection of the at least one region of interest 25 by a user of the measuring device 5 is possible.

The alignment module 31 is preferably configured to automatically determine at least one alignment, selected from the annual alignment and the translational alignment, of the blueprint coordinate system relative to the build level coordinate system. Alternatively or additionally, the user interface 43 is preferably configured such that the at least one alignment can be selected by the user of the measuring device 5 via this interface.

The measuring device 5 preferably comprises a representation module 45, which is configured to calculate an overall representation of the region of interest 25 in the first coverage region 21, in particular by overlaying a first representation of the first coverage region 21 with a second representation of the region of interest 25 and/or by offsetting the first representation of the first coverage region 21 with the second representation of the region of interest 25 to form the overall representation.

The representation module 45 is preferably configured to calculate an AR representation of the working region 13 such that, in the AR representation, the overall representation is displayed in the working region 13, in particular in a visual recording of the working region 13—in particular recorded in real time—preferably by overlaying the overall representation with the working region 13, in particular with the visual recording of the working region 13.

The representation module 45 is preferably configured to display at least one coordinate system selected from the build level coordinate system and the blueprint coordinate system in the overall representation or in the AR representation. Alternatively or additionally, the representation module 45 is configured to display irradiation vectors for the generative manufacturing of the component part 3 in the working region 13 in the overall representation or in the AR representation.

The manufacturing device 1 preferably comprises an output device 47, which is operationally connected to the measuring device 5, in particular to the representation module 45, in particular to the control device 17 here, and is configured to output at least one representation calculated by the representation module 45, selected from the overall representation and the AR representation.

The alignment module 31 is preferably configured to link location information along a coordinate extending perpendicularly to the build level 11 with at least one coordinate system selected from the build level coordinate system and the blueprint coordinate system.

The alignment module 31 is preferably configured to align a plurality of optical working beams 9 of the manufacturing device 1 relative to at least one coordinate system selected from the build level coordinate system and the blueprint coordinate system.

FIG. 2 shows a schematic representation of a second exemplary embodiment of the manufacturing device 1 for generatively manufacturing a component part 3 from a powder material 4 with a second exemplary embodiment of the measuring device 5.

Elements that are the same or functionally equivalent are provided with the same references in all the figures, so that in this regard reference is respectively made to the preceding description.

In the second exemplary embodiment of the measuring device 5, the second sensor device 29 comprises a thermal imaging camera 49, which is arranged and configured to cover the working region 13, wherein the second sensor device 29 is configured to detect the signal values in a location-dependent manner by recording a thermal image using the thermal imaging camera 49.

In the scope of a preferred embodiment of a method for operating the manufacturing device 1, first coverage region 21 is covered with a first measurement accuracy. The at least one region of interest 25 is selected within the first coverage region 21, and the at least one selected region of interest 25 is covered with a second measurement accuracy, wherein the second measurement accuracy is higher than the first measurement accuracy. At least one alignment of the blueprint coordinate system relative to the build level coordinate system selected from the angle alignment and the translation alignment is determined on the basis of the covered region of interest 25.

The angle alignment is preferably determined on the basis of at least one covered region, selected from the covered first coverage region 21 and the covered region of interest 25, while the translation alignment is determined on the basis of the covered region of interest 25.

A geometric location of the at least one preform 35 in the build level 11 relative to the at least one coordinate system selected from the build level coordinate system and the blueprint coordinate system is preferably ascertained, and the component part 3 is built up generatively on the preform 35.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A measuring device for aligning a blueprint coordinate system with a build level coordinate system of a working region of a generative manufacturing device arranged in a build level, the measuring device comprising
a first sensor device configured to cover a first coverage region of the working region with a first measurement accuracy,
a selection module configured to select at least one region of interest within the first coverage region,
a second sensor device configured to cover the at least one selected region of interest with a second measurement accuracy, wherein the second measurement accuracy is higher than the first measurement accuracy, and
an alignment module configured to determine at least one alignment of the blueprint coordinate system relative to the build level coordinate system, including an angle alignment and/or a translation alignment, based on the covered region of interest.

2. The measuring device according to claim 1, wherein the alignment module is configured to determine the angle alignment of the blueprint coordinate system relative to the build level coordinate system based on at least one covered region, including the covered first coverage region and/or the covered region of interest, and to determine the translation alignment of the blueprint coordinate system relative to the build level coordinate system based on the covered region of interest.

3. The measuring device according to claim 1, wherein the alignment module is configured to identify at least one location determination feature of at least one preform arranged in the working region, and
to define a geometric location of the at least one location determination feature relative to at least one coordinate system, including the build level coordinate system and/or the blueprint coordinate system, and/or
to align the blueprint coordinate system relative to the at least one location determination feature.

4. The measuring device according to claim 1, wherein the first sensor device comprises an optical sensor device configured to record an optical image of the first coverage region.

5. The measuring device according to claim 1, wherein the second sensor device is configured
to activate a scanner device for moving an optical working beam of the generative manufacturing device in the working region,
to detect signal values from electromagnetic radiation originating from an interaction region of the optical working beam in the working region in a location-dependent manner, wherein a respective signal value of the signal values is assigned to each location of the movement of the optical working beam in the working region, and
to obtain an image of the working region from the signal values detected in the location-dependent manner.

6. The Measuring device according to claim 5, wherein the second sensor device
comprises a detection device arranged on an optical axis of the optical working beam and configured to detect a respective signal value in the location-dependent manner in that an output signal of the detection device is assigned in a time-dependent manner to a synchronous state of the scanner device, and/or
comprises a thermal imaging camera arranged and configured to cover the working region, wherein the second sensor device is configured to detect a respective signal value in the location-dependent manner by recording a thermal image using the thermal imaging camera.

7. The measuring device according to claim 1, wherein the selection module is configured
to select the at least one region of interest automatically, and/or
to provide a user interface that enables the selection of the at least one region of interest by a user of the measuring device.

8. The measuring device according to claim 1, wherein the alignment module is configured
to automatically determine the at least one alignment, including the angle alignment and/or the translation alignment, of the blueprint coordinate system relative to the build level coordinate system, and/or
to provide a user interface that enables the determination of the at least one alignment, including the angle alignment and/or the translation alignment, of the blueprint coordinate system relative to the build level coordinate system by a user of the measuring device.

9. The measuring device according to claim 1, further comprising a representation module configured to calculate an overall representation of the region of interest in the first coverage region, by
overlaying a first representation of the first coverage region with a second representation of the region of interest and/or
offsetting the first representation of the first coverage region with the second representation of the region of interest to form the overall representation.

10. The measuring device according to claim 9, wherein the representation module is configured to calculate an augmented reality (AR) representation of the working region such that in the AR representation, the overall representation is displayed in the working region, by overlaying the overall representation with the working region.

11. The measuring device according to claim 9, wherein the representation module is configured, in the overall representation,
to display at least one coordinate system including the build level coordinate system and/or the blueprint coordinate system, and/or
to display irradiation vectors for generative manufacturing of a component part in the working region.

12. The measuring device according to claim 1, wherein the alignment module is configured to link location information along a coordinate extending perpendicular to the build level with at least one coordinate system including the build level coordinate system and/or the blueprint coordinate system.

13. The measuring device according to claim 1, wherein the alignment module is configured to align a plurality of optical working beams of the manufacturing device relative to at least one coordinate system including the build level coordinate system and/or the blueprint coordinate system.

14. A manufacturing device for generatively manufacturing a component part from a powder material, the manufacturing device comprising:
a beam device configured to generate at least one optical working beam to manufacture the component part generatively from a powder material,
a working region arranged in a build level and configured to generatively manufacture the component part from the powder material in the working region,
at least one scanner device configured to move the at least one optical working beam in the working region,
a control device operationally connected to the at least one scanner device and configured to activate the at least one scanner device to move the at least one optical working beam in the working region, and
a measuring device according to claim 1.

15. The manufacturing device according to claim 14, further comprising an output device operationally connected to the measuring device and configured to output at least one representation calculated by an representation module, including an overall representation and/or an augmented reality (AR) representation.

16. A method for operating a manufacturing device for generatively manufacturing a component part from a powder material, the method comprising:
covering a first coverage region of a working region of the manufacturing device arranged in a build level with a first measurement accuracy,
selecting at least one region of interest within the first coverage region,
covering the at least one selected region of interest with a second measurement accuracy, wherein the second measurement accuracy is higher than the first measurement accuracy, and
determining at least one alignment of a blueprint coordinate system relative to a build level coordinate system including an angle alignment and/or a translation alignment based on the covered region of interest.

17. The method according to claim 16, wherein the angle alignment of the blueprint coordinate system relative to the build level coordinate system is determined based on the at least one covered region, including the covered first coverage region and/or the covered region of interest, and wherein the translation alignment of the blueprint coordinate system relative to the build level coordinate system is determined based on the covered region of interest.

18. The method according to claim 16, further comprising ascertaining a geometric location of at least one preform in the build level relative to at least one coordinate system including the build level coordinate system and/or the blueprint coordinate system, and wherein the component part is generatively manufactured on the preform.
